(19) United States
(12) Patent Application Publication
(10) Pub. No.: US 2026/0095383 A1
(43) Pub. Date: Apr. 2, 2026

(54) GENERATING WAIT TIME PREDICTIONS WITH MACHINE LEARNING

(71) Applicant: eBay Inc., San Jose, CA (US)

(72) Inventors: Megha Nivrutti Korade, Milpitas, CA (US); Peter Joseph Libis, Roseville, CA (US); Glen Edward Campbell, St. George, UT (US); Vladimir Deryugin, Concord, CA (US)

(73) Assignee: eBay Inc., San Jose, CA (US)

(21) Appl. No.: 18/900,530

(22) Filed: Sep. 27, 2024

(51) Int. Cl. H04L 41/147; G06N 20/00

(52) U.S. Cl. CPC H04L 41/147; G06N 20/00

(57) ABSTRACT

In the implementation of techniques for generating wait time predictions with machine learning, a system receives time series data and contextual data corresponding to a plurality of communication requests. Based on the time series data and the contextual data, a system trains a machine learning model to generate a wait time prediction for a communication request. The system receives the communication request from a client device and recent time series data and recent contextual data corresponding to recent communication requests. Based on the recent time series data and the recent contextual data, the system updates the machine learning model. Based on the communication request, the system generates the wait time prediction via the updated machine learning model. Upon generation of the wait time prediction, the system broadcasts the wait time prediction to the client device.

### BACKGROUND

Conventional techniques for generating wait time predictions for communication requests often fail to account for changing operational conditions. Examples of changing operational conditions include variations in communication request volume, agent availability, and a number of high priority communication requests. Changes in the time of day also play a role in the changing operational conditions. Consequently, the conventional techniques result in imprecise wait time predictions.

### SUMMARY

Techniques and systems for generating wait time predictions with machine learning are described. In an example, a computing device receives data corresponding to a plurality of communication requests (e.g., historical communication session requests), in which the data includes time series data and contextual data corresponding to the communication requests. Based on the time series data and the contextual data, the computing device trains a machine learning model to generate a wait time prediction for a communication request.

The computing device receives the communication request and recent time series data and recent contextual data corresponding to a plurality of recent communication requests. Based on the recent time series data and the recent contextual data, the computing device updates the machine learning model. Upon updating the machine learning model, the computing device generates a wait time prediction for the communication request. The computing device broadcasts the wait time prediction for the communication request.

The disclosed techniques and systems enable efficient techniques for generating wait time predictions with machine learning without inefficient utilization or scaling of computing resources by leveraging data (e.g., time series data, etc.) corresponding to a plurality of communication requests.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of a digital medium environment in an example implementation that is operable to employ techniques and systems for generating wait time predictions with machine learning as described herein.

FIG. 2 depicts a system 200 in an example implementation showing operation of the communication management system for training a machine learning model for generating wait time predictions.

FIG. 3 depicts a system in an example implementation showing operation of the communication management system for generating a wait time prediction for a communication request based on recent data corresponding to recent communication requests.

FIG. 4 depicts a system in an example implementation showing operation of the communication management system for generating an updated wait time prediction for a communication request based on additional recent data corresponding to additional recent communication requests.

FIG. 5 depicts an example implementation of a user interface configured to receive a communication request via user input.

FIG. 6 depicts an example implementation of a user interface configured to broadcast a wait time prediction generated with machine learning.

FIG. 7 depicts an example implementation of a user interface configured to broadcast an updated wait time prediction generated with machine learning.

FIG. 8 depicts a procedure in an example implementation of generating wait time predictions with machine learning.

FIG. 9 illustrates an example system including various components of an example device that can be implemented as any type of computing device as described and/or utilized with reference to FIGS. 1-8 to implement examples of the techniques described herein.

### DETAILED DESCRIPTION

### Overview

Conventional techniques for predicting wait times for communication requests often result in imprecise wait time predictions because the conventional techniques fail to effectively account for fluctuating operational conditions and real-time changes inherent in communication request operations.

By way of example, the conventional techniques fail to address the challenge of blended agents in communication request operations. In the context of communication request operations, blended agents are agents that provide digital services to a plurality of virtual queues instead of merely a single virtual queue. The dynamic nature of blended agents results in challenges in reliably predicting an actual number of agents available for providing digital services to any particular virtual queue. Because operational conditions inherent in communication request operations — such as the actual number of agents available or the type of agents available — frequently fluctuate and are often not accounted for by the conventional techniques, the conventional techniques result in imprecise wait time predictions in addition to other adverse outcomes.

However, techniques for generating wait time predictions with machine learning are described that overcome these limitations by generating more precise wait time predictions. For instance, consider an example in which Alice, a user of a service provider system, encounters a technical issue with a digital service of the service provider system. Logging into a platform of the service provider system via a secure user interface of her client device, Alice inputs a request to initiate a live messaging session to address the technical issue via her user account. She selects ‘instant messaging’ as a preferred communication channel and emphasizes an urgency for a prompt resolution via her user input. The request includes additional information corresponding to the request, such as relevant time information.

A communication management system receives the request, in addition to recent time series data and recent contextual data corresponding to a plurality of recent communication requests. A machine learning model of the communication management system, already trained on communication data corresponding to communication requests, such as time series data like datetimes corresponding to the communication requests, and contextual data such as a number of communication requests in a queue, is configured to generate wait time predictions.

Based on the recent time series data and the recent contextual data, the communication management system updates the machine learning model to account for recent operational conditions. In some examples, the communication management system updates the machine learning model by generating one or more moving averages for recent wait times for one or more communication session requests of the plurality of recent communication requests and by using the one or more moving averages.

Based on the communication request, the communication management system generates, with the machine learning model, a wait time prediction for the communication request. The communication management system broadcasts the wait time prediction for the communication request. The wait time prediction is displayed via the user interface of Alice’s client device. While the communication request is pending, the communication management system continues to adjust the wait time predictions in real-time. The communication management system uses the machine learning model to monitor additional recent communication data from recent communication requests.

This adaptive approach enables the generation of wait time predictions with machine learning that is continually optimized for recent and real-time conditions, thereby enhancing precision of the wait time predictions and efficacy of the machine learning model. Therefore, the described techniques for generating wait time predictions with machine learning resolve the shortcomings of the conventional techniques, which fail to account for real-time changes in communication management operations.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Environment

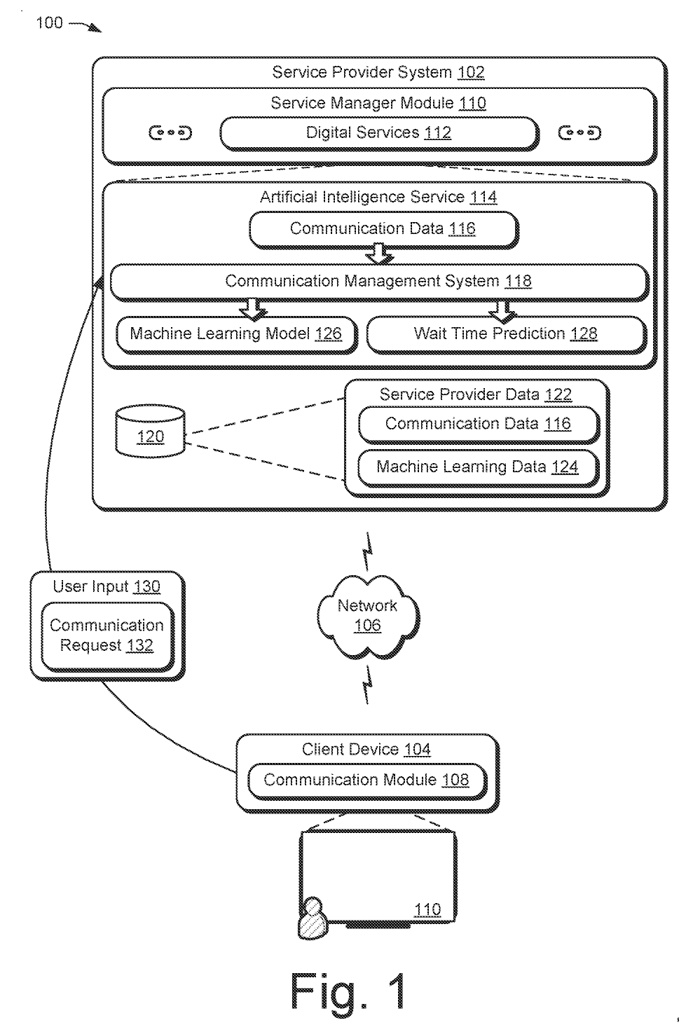

FIG. 1 is an illustration of a digital medium environment 100 in an example implementation that is operable to employ techniques and systems for generating wait time predictions with machine learning.

The illustrated environment 100 includes a service provider system 102 and a client device 104 that are communicatively coupled, one to another, via a network 106. Computing devices that implement the service provider system 102 and the client device 104 are configurable in a variety of ways.

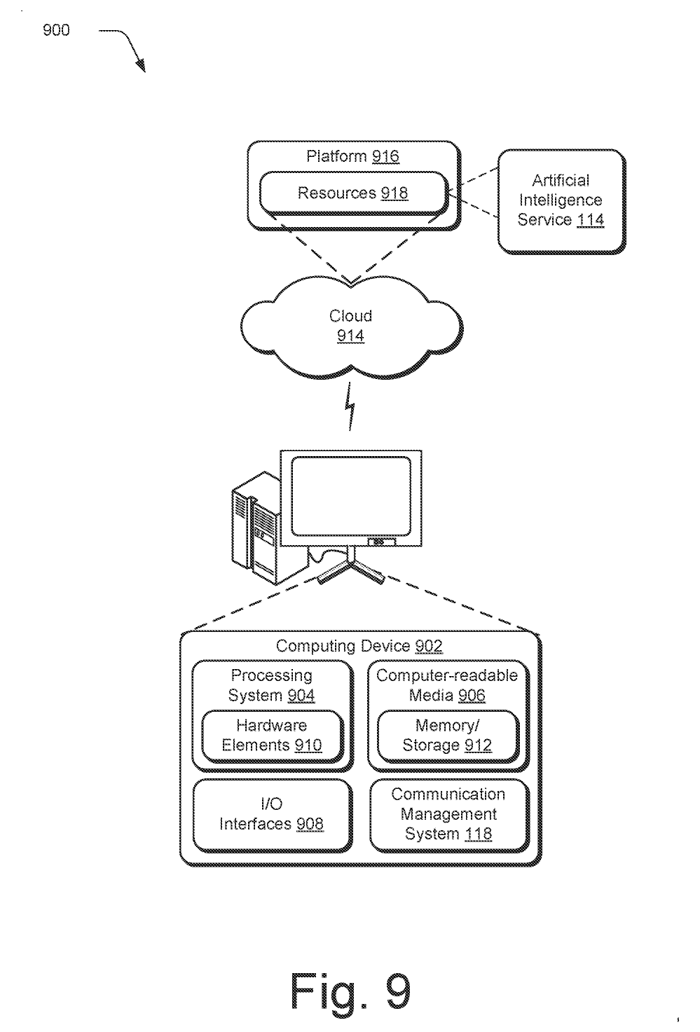

A computing device, for instance, is configurable as a desktop computer, a laptop computer, a mobile device (e.g., assuming a handheld configuration such as a tablet or mobile phone), and so forth. Thus, a computing device ranges from full resource devices with substantial memory and processor resources (e.g., personal computers, game consoles) to a low-resource device with limited memory and/or processing resources (e.g., mobile devices). Additionally, although a single computing device is described in some examples, a computing device is also representative of a plurality of different devices, such as multiple servers utilized to perform operations “over the cloud” as described in FIG. 9.

The client device 104 includes a communication module 108 that is representative of functionality to communicate via the network 106 with a service manager module 110 of the service provider system 102. The service manager module 110 is configured to implement digital services 112. Digital services 112 are usable to expose a variety of functionality to the client device 104, an example of which is illustrated as an artificial intelligence service 114. The artificial intelligence service 114 is configured to manage artificial intelligence content based on received inputs. The artificial intelligence service 114, for instance, is configurable to generate and deploy artificial intelligence models, to manage allocation of computing resources pertaining to the artificial intelligence models generated, to generate wait time predictions via artificial intelligence models, and so forth.

In the illustrated example, the artificial intelligence service 114 employs communication data 116, in which the communication data 116 includes data corresponding to a plurality of communication requests (e.g., the communication request 132, historical communication requests, and so forth) of the digital services 112 of the service provider system 102. Examples of the communication data 116 include time series data pertaining to each respective communication request of the plurality of communication requests, contextual data pertaining to the each respective communication request of the plurality of communication requests, and so forth.

Examples of the communication data 116 include identifiers of virtual queues corresponding to the each respective communication request, a wait time prediction (e.g., a current wait time prediction) for the each respective communication request, a priority level assigned for the each respective communication request, a medium through which a respective communication request is received for the each respective communication request, a communication session end time for the each respective communication request, a communication session start time for the each respective communication request, an interaction type (e.g., a technical support type) for the each respective communication request, a number of agent devices logged in at a receipt time for the each respective communication request, a number of blended agent devices logged in at a receipt time for the each respective communication request, an actual wait time for the each respective communication request, and so forth.

The identifiers of the virtual queues represent a specific virtual queue assigned for a communication request of the plurality of communication requests. The current wait time prediction denotes the wait time prediction as currently predicted by the machine learning model 126. The priority level assigned to the communication requests categorizes each communication request of the plurality of communication requests based on its urgency or importance, whether predefined or assigned based on predefined criteria of the service provider system 102. The medium through which the communication request 132 is received indicates the medium of interaction, such as phone, online chat messaging, or email.

The communication session end times and start times are employable by the communication management system 118 to calculate the actual duration of each communication session for the each respective communication request, and to therefore generate temporal context for the artificial intelligence service 114 to enhance precision in its generation of wait time predictions. The number of agent devices logged in directly reflects capacity for digital services 112 pertaining to communications of the digital services 112. The maximum wait time experienced by any user account provides an extremity measure. Actual wait times represent real wait times experienced by user accounts for the each respective communication request.

Examples of time series data include but are not limited to a plurality of datetimes (e.g., datetimes corresponding to communication requests), a day of a year, an hour of the day, a month of the year, a minute of the day, a day of a week, or a quarter of the year during which a communication request was received, and so forth. Examples of the contextual data include (e.g., for each communication request, at a time of receipt), a number of agent devices available, a priority type, a category type, a number of communication requests in a queue, and so forth. In some examples, the contextual data includes operational metrics relevant to a communication management system 118 employed by the artificial intelligence service 114.

The communication management system 118 is configured for managing communications (e.g., communication requests, communication sessions, etc.) and models (e.g., machine learning models) pertaining to the communications of the service provider system 102. The communication management system 118, in some instances, generates machine learning models 126. Examples of the generating of the machine learning model 126 include training the machine learning model 126, configuring a pre-trained machine learning model for the machine learning model 126, and selecting a pre-existing machine learning model for the machine learning model 126. The communication management system 118 utilizes service provider data 122 (e.g., the communication data 116 and machine learning data 124, which includes data pertaining to machine learning and the artificial intelligence service 114) to configure machine learning models (e.g., machine learning model 126) and to generate wait time predictions 128.

The machine learning model 126 represents the one or more artificial intelligence models generated, trained, and/or deployed by the communication management system 118. The machine learning models 126 are configured to perform a variety of tasks, such as complex predictive analytics for generating predictions for wait times or predictions of conditions for the communication management system 118 for current or future times, based on the inputs (e.g., the communication data 116) and configurations processed by the communication management system 118. The effectiveness and efficiency of the machine learning models 126 are, in some instances, continuously monitored and improved upon by utilizing real-time metrics and historical data of the service provider data 122, which includes the machine learning data 124 and the communication data 116.

The storage device 120 of the service provider system 102 includes the service provider data 122 including data pertaining to the offerings (e.g., the digital services 112) and operations of the service provider system 102. The service provider data 122 includes the communication data 116 pertaining to the communication services (e.g., communication sessions, communication requests, and so forth) of the service provider system 102, and the machine learning data 124 pertaining to the machine learning operations of the communication management system 118.

In some instances, the machine learning data 124 includes data supporting the training, configuration, and optimization of the machine learning model 126. Examples of the machine learning data 124 include training data, parameters for model behavior, performance metrics, and historical operational data.

User input 130 and communication requests 132 are provided to the service provider system 102 and the artificial intelligence service 114 via the communication module 108 of the client device 104. The user input 130 includes various types of user input 130, such as selections, clicks, spoken input, recognized facial input, specifications, commands, or queries provided by users via a user interface. Examples of the communication request 132 include various types of requests for initiating a communication, such as communication sessions of various types of mediums.

The components of the service provider system 102 and the computing device 104 create a robust framework for deploying and managing the artificial intelligence services 114, and for dynamically (e.g., in real time) generating more precise wait time predictions 128 during changing operational circumstances. Further discussion of these and other examples is included in the following sections and shown in corresponding figures.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Generating Wait Time Predictions With Machine Learning

The following discussion describes techniques that are implementable utilizing the previously described systems and devices. Aspects of each of the procedures are implemented in hardware, firmware, software, or a combination thereof. The procedures are shown as a set of blocks that specify operations performed and/or caused by one or more devices and are not necessarily limited to the orders shown for performing the operations by the respective blocks.

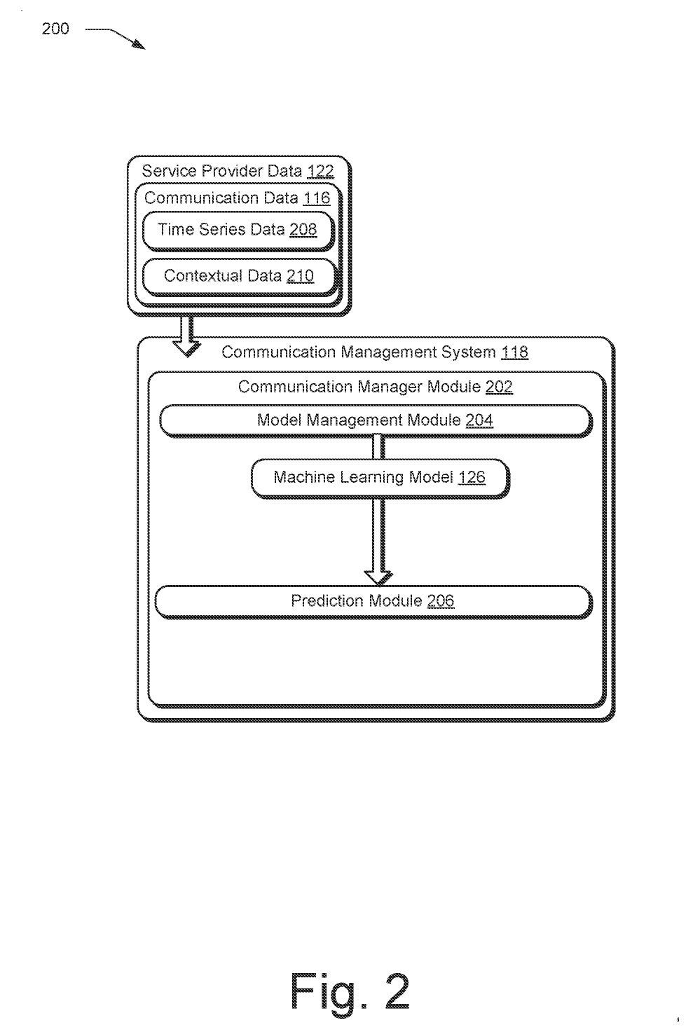

FIG. 2 depicts a system 200 in an example implementation showing operation of the communication management system 118 of FIG. 1 in greater detail as training a machine learning model 126 for generating wait time predictions 128. The communication management system 118 implemented in this example includes a communication manager module 202 including a model management module 204 and a prediction module 206.

The communication management system 118 is illustrated as receiving the service provider data 122, in which the service provider data 122 includes the communication data 116 of FIG. 1, in which the communication data 116 includes time series data 208 and contextual data 210 corresponding to communication requests received by the service provider system 102. Examples of the time series data 208 include but are not limited to a plurality of datetimes (e.g., datetimes corresponding to communication requests), a day of a year, an hour of the day, a month of the year, a minute of the day, a day of a week, or a quarter of the year during which a communication request was received, and so forth.

As discussed throughout, examples of the contextual data 210 include (e.g., for each communication request, at a time of receipt), a number of agent devices available, a priority type, a category type, a number of communication requests in a queue, and so forth. In some examples, the contextual data includes operational metrics relevant to the communication management system 118. In some embodiments, the communication management system 118 is configured to receive the service provider data 122 from the communication module 108 from a computing device 104.

The communication manager module 202 of the communication management system 118 is configured to manage the machine learning models 126, such as the generation of the machine learning models 126, and the service provider data 122 for the management of the machine learning models 126. The communication manager module 202 of the communication management system 118 is configurable in a variety of ways, including receiving the service provider data 122, the communication data 116, the machine learning data 124, the time series data 208, the contextual data 210, the communication requests 132, and the user inputs 130, for instance, from the service provider system 102, the client device 104, the communication management system 118, and so forth. The communication manager module 202, as illustrated, passes the service provider data 122 including the communication data 116 (including the time series data 208 and the contextual data 210) to the model management module 204 of the communication manager module 202.

To continue this illustrated example system 200, the model management module 204 is configurable to generate machine learning models 126 in a variety of ways, including based on the various service provider data 122 received, such as the time series data 208 or the contextual data 210. In some examples, the model management module 204 generates the machine learning model 126 based on one or more of the service provider data 122 received, such as the time series data 208 or the contextual data 210.

In this illustrated example system 200, the model management module 204 is illustrated as generating and training the machine learning model 126 based on the time series data 208 and the contextual data 210. In some embodiments, the model management module 204 trains the machine learning model 126 by using a gradient boosting machine learning algorithm (e.g., XGBoost), however, any machine learning algorithm is usable by the model management module 204.

Additionally, or alternatively, the model management module 204 uses time series analysis techniques for the training of the machine learning model 126. In some examples, the model management module 204 leverages auto regressive integrated moving averages. In some implementations, the model management module 204 uses a loss function (e.g., a pseudo-Huber loss function, a Huber loss function, etc.) as part of the training of the machine learning model 126.

In some embodiments, the model management module 204 is configured to apply a predefined rule-based filter (e.g., for high priority communication requests) to the time series data (e.g., recent time series data) and the contextual data (e.g., recent contextual data) to extract filtered time series data and filtered contextual data, and to train the machine learning model 126 by using the filtered time series data and the filtered contextual data.

In some examples, the model management module 204 trains the machine learning model 126 to identify, detect, analyze, or extrapolate patterns (e.g., seasonality patterns, wait time patterns, and so forth) or trends in the service provider data 122, such as in the time series data 208 and/or the contextual data 210. In some embodiments, the model management module 204 trains the machine learning model 126 to extrapolate a wait time pattern by utilizing active past wait times from the communication data 116.

In some embodiments, the model management module 204 trains the machine learning model 126 to monitor any changes in a wait time pattern that exceed a predefined threshold amount representing one or more measures of change. The measures of changes may be output in various ways, examples of which include but are not limited to percentage ratios, normalized scores, probabilities, percentages, fractions, numerically, and so forth. In some examples, the model management module 204 trains the machine learning model 126 to detect actual wait times that exceed a predefined threshold wait time amount (e.g., a numerical predefined threshold wait time amount) and to trigger an action responsive to the detecting.

The model management module 204 is configured to pass a variety of data to the prediction module 206 or other modules of the communication manager module 202, such as the service provider data 122, the communication data 116, the time series data 208, the contextual data 210, the machine learning model 126, and so forth. The model management module 204, as illustrated, passes the machine learning model 126 to the prediction module 206.

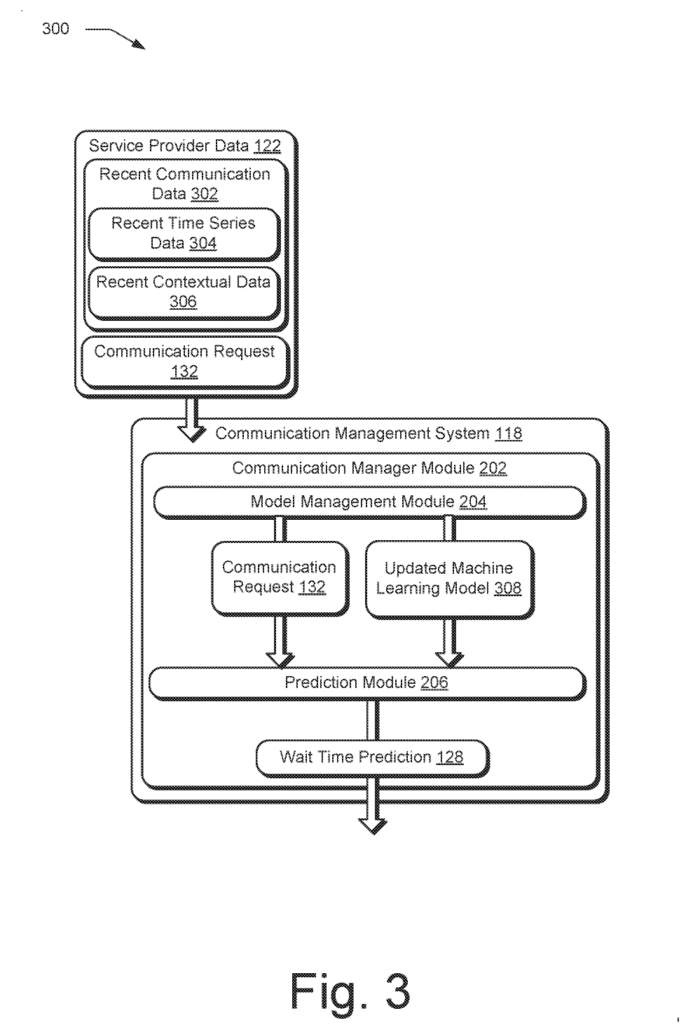

As discussed throughout, the prediction module 206 is configured to generate predictions pertaining to the communication management system 118 or the service provider system 102. Examples of the predictions include predictions for real-time or future operational conditions of the communication management system 118 or wait times for communication requests 132. In the context of the communication management system 118, consider the following discussion of FIG. 3.

FIG. 3 depicts a system 300 in an example implementation showing operation of the communication management system 118 of FIGS. 1 and 2, in which the communication management system 118 generates a wait time prediction 128 for a communication request 132 based on recent communication data 302 corresponding to recent communication requests.

As already noted, the illustrated system 300 includes the communication management system 118 of FIG. 1, in which the communication management system 118 includes the communication manager module 202 including the model management module 204 and prediction module 206 of FIG. 2.

To begin this example of the system 300, the communication manager module 202 of the communication management system 118 receives the service provider data 122 including recent communication data 302 pertaining to recent communication requests, in addition to a communication request 132. The recent communication data 302 includes recent time series data 304 and recent contextual data 306. The recent time series data 304 and the recent contextual data 306 correspond to the recent communication requests received by the service provider system 102.

The communication manager module 202, as illustrated, passes the service provider data 122 including the recent communication data 302 and the communication request 132 to the model management module 204 of the communication manager module 202. As discussed throughout, the model management module 204 is configured to generate machine learning models 126 or updated machine learning models 308 (e.g., updated versions of the machine learning models 126) in a variety of ways, including based on the various service provider data 122 received, such as the recent time series data 304 or the recent contextual data 306. In some examples, the model management module 204 updates the machine learning model 126 to generate the updated machine learning model 308 based on one or more of the service provider data 122 received, such as the recent time series data 304, the recent contextual data 306, or the communication request 132.

In this illustrated example system 300, the model management module 204 is illustrated as updating the machine learning model 126 to the updated machine learning model 308 based on the recent time series data 304 and the recent contextual data 306. In some embodiments, the model management module 204 generates the updated machine learning model 308 by generating moving averages for current wait times for one or more recent communication requests of the plurality of recent communication requests. Additionally, or alternatively, the model management module 204 generates the updated machine learning model 308 by using the one or more moving averages for the current wait times.

In some examples, the model management module 204 extracts one or more recent actual wait times for one or more of the recent communication requests based on the recent time series data 304 and the recent contextual data 306, and generates the updated machine learning model 308 by using the one or more recent actual wait times.

In some embodiments, based on the recent time series data 304 and the recent contextual data 306, the model management module 204 generates one or more average wait times for one or more past time periods for one or more of the recent communication requests. Additionally, or alternatively, the model management module 204 generates the updated machine learning model 308 by using the one or more average wait times from the one or more past time periods for the one or more recent communication requests. In some implementations, an average wait time of the one or more average wait times from the one or more past time periods is for a predefined period of time, such as a past minute.

In some examples, the model management module 204 is configured to assign a category type (e.g., a priority type) for the communication request 132 based on one or more of the communication request 132, the recent time series data 304, or the recent contextual data 306, and wherein the generating of the wait time prediction 128 for the communication request 132 is based at least in part on the category type.

In this illustrated example system 300, the model management module 204 is illustrated as passing the communication request 132 and the updated machine learning model 308 to the prediction module 206 from FIG. 2. Based at least in part on the communication request 132, the prediction module 206 generates a prediction (e.g., the wait time prediction 128) for the communication request 132. In some examples, the prediction module 206 generates the wait time prediction 128 with the updated machine learning model 308 based on the communication request 132.

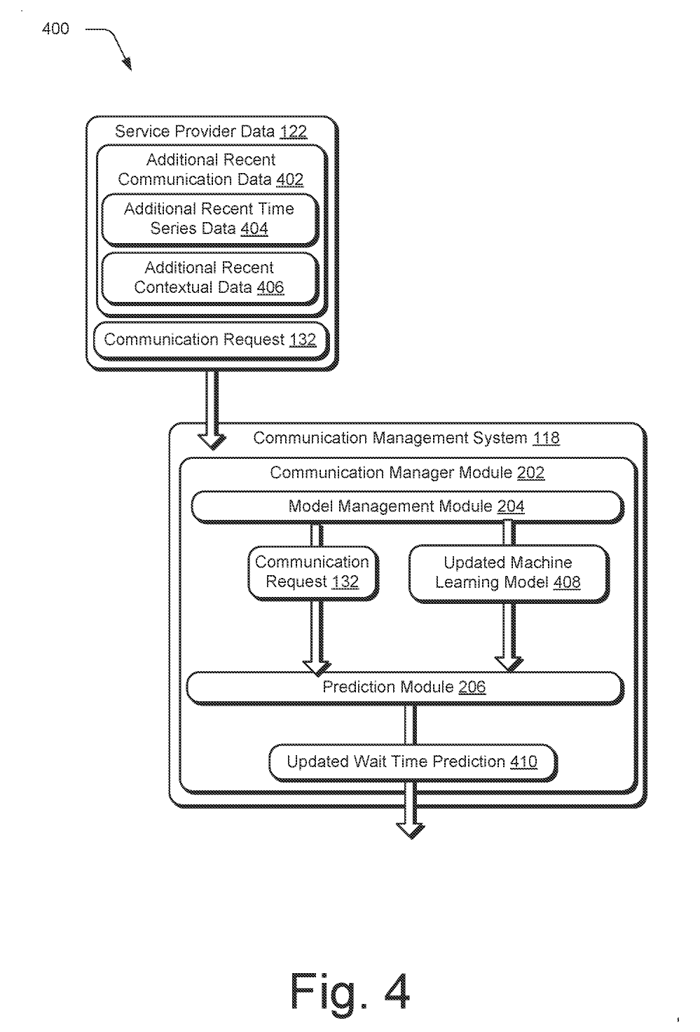

The prediction module 206 is configured to pass the prediction (e.g., the wait time prediction 128) to the communication module 108 of the client device 104. In some examples, the prediction module 206 is configured to render and/or generate one or more representations of the wait time prediction 128. Examples of the representations include audio representations, visual representations for display, and so forth. The prediction module 206 is also configured to generate and broadcast other information pertaining to the wait time prediction 128, such as a user account’s communication request’s 132 position in a digital queue, a duration of time since the last wait time prediction 128 was generated or broadcasted, and so forth. In the context of the communication management system 118, consider the following discussion of FIG. 4.

FIG. 4 depicts a system 400 in an example implementation showing operation of the communication management system 118 of FIGS. 1 and 2, in which the communication management system 118 generates an updated wait time prediction 410 for a communication request 132 based on additional recent communication data 402 corresponding to additional recent communication requests.

To begin this example of the system 400, the communication manager module 202 of the communication management system 118 receives the service provider data 122 including additional recent communication data 402 pertaining to additional recent communication requests, in addition to the communication request 132. The additional recent communication data 402 includes additional recent time series data 404 and additional recent contextual data 406. The additional recent time series data 404 and the additional recent contextual data 406 correspond to the additional recent communication requests received by the service provider system 102 since the recent communication requests of FIG. 3.

The communication manager module 202, as illustrated, passes the service provider data 122 including the additional recent communication data 402 and the communication request 132 to the model management module 204 of the communication manager module 202. As discussed throughout, the model management module 204 is configured to generate machine learning models 126 or updated machine learning models 308 or 408 (e.g., updated versions of the machine learning models 126) in a variety of ways, including based on the various service provider data 122 received, such as the additional recent time series data 404 or the additional recent contextual data 406.

In this illustrated example, the model management module 204 updates the machine learning model 308 of FIG. 3 to generate the updated machine learning model 408 based on one or more of the service provider data 122 received, such as the additional recent time series data 404, the additional recent contextual data 406, or the communication request 132.

In this illustrated example system 300, the model management module 204 is illustrated as updating the machine learning model 308 to the updated machine learning model 408 based on the additional recent time series data 404 and the additional recent contextual data 406. In some embodiments, the model management module 204 generates the updated machine learning model 408 by generating one or more moving averages for current wait times for one or more additional recent communication requests of the plurality of additional recent communication requests, and generating the updated machine learning model 408 by using the one or more moving averages for the current wait times.

In some examples, the model management module 204 extracts one or more additional recent actual wait times for one or more of the additional recent communication requests based on the additional recent time series data 404 and the additional recent contextual data 406, and generates the updated machine learning model 408 by using the one or more additional recent actual wait times.

In some embodiments, based on the additional recent time series data 404 and the additional recent contextual data 406, the model management module 204 generates one or more additional average wait times for one or more past time periods for the one or more of the additional recent communication requests, and generates the updated machine learning model 308 by using the one or more additional average wait times from the one or more past time periods for the one or more additional recent communication requests. In some implementations, an additional average wait time of the one or more additional average wait times from the one or more past time periods is for a past minute.

In some examples, the model management module 204 is configured to assign a category type (e.g., a priority type) for the communication request 132 based on one or more of the additional recent communication requests, the additional recent time series data 404, or the additional recent contextual data 406, and to generate the updated wait time prediction 410 for the communication request 132 based at least in part on the category type.

In this illustrated example system 300, the model management module 204 is illustrated as passing the communication request 132 and the updated machine learning model 408 to the prediction module 206 from FIG. 2. Based at least in part on the communication request 132, the prediction module 206 generates a prediction (e.g., the updated wait time prediction 410) for the communication request 132 by using the updated machine learning model 408.

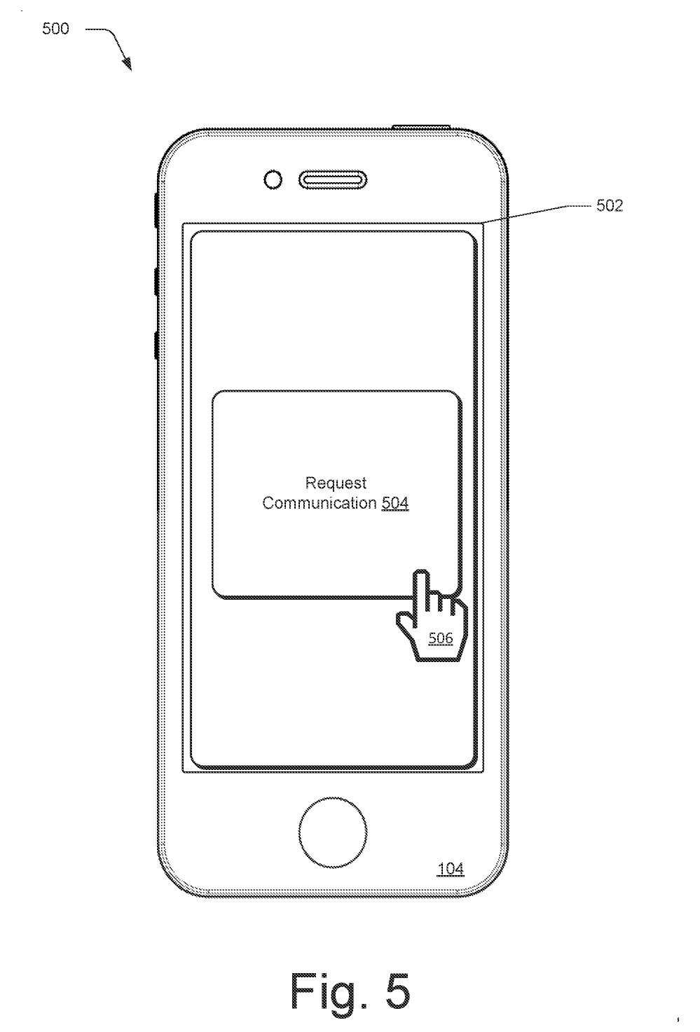

The prediction module 206 is configured to pass the prediction (e.g., updated wait time prediction 410), for instance, to the communication module 108 of the client device 104. In some examples, the prediction module 206 is configured to render and/or generate one or more representations of the updated wait time prediction 410. Examples of the representations include audio representations, visual representations for display via the client device 104, and so forth. The prediction module 206 is also configured to generate and broadcast other information pertaining to the updated wait time prediction 410, such as a user account’s communication request’s 132 position in a digital queue, a duration of time since the last updated wait time prediction 410 was generated or broadcasted, and so forth. In the context of the communication management system 118, consider the following discussion of FIG. 5.

FIG. 5 depicts an example implementation 500 of a user interface 502 configured to receive a communication request 132 via user input 506. The user interface 502, as illustrated for the computing device 104, includes a selectable visual element 504 for receiving the communication request 132 via the user input 506. The user interface 502 is configured to present a variety of formats, such as text, a slider bar, and so forth. In some examples, the communication module 108 of the client device 104 receives the user input 506 and passes the selections to other modules, such as the communication management module 204.

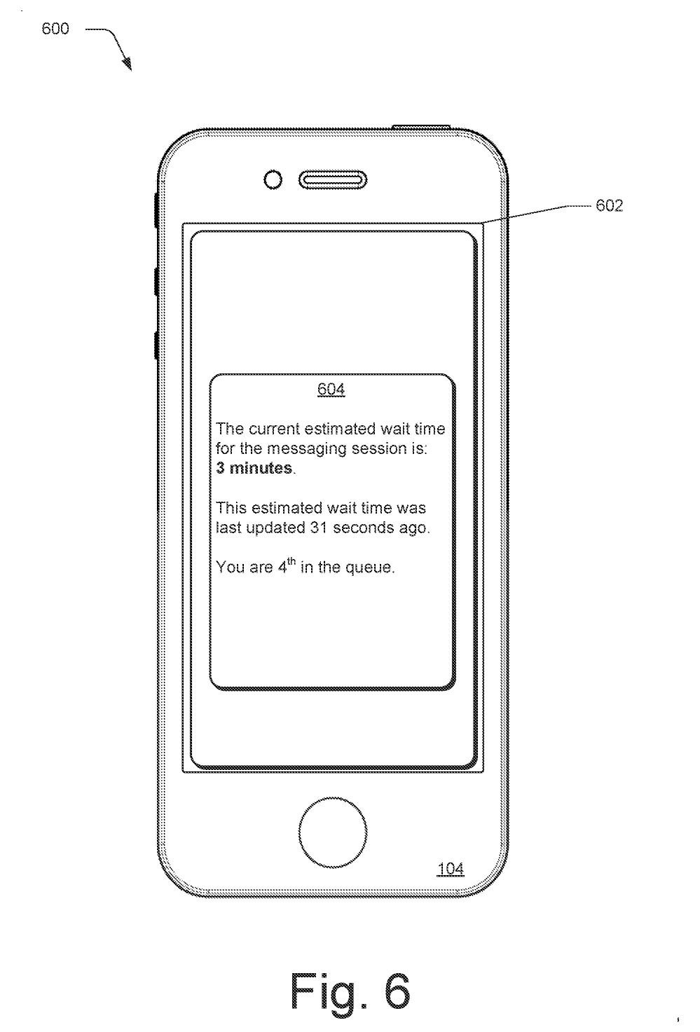

The user interface 502 and the communication module 108 are configured to recognize various types of the user input 506, including but not limited to typing text into fields (e.g., a description of the purpose of the communication request, contact information, etc.), selecting options from dropdown menus, clicking or tapping on buttons or links, toggling switches, dragging and dropping objects, providing voice commands, and uploading files. In the context of generating and broadcasting a wait time prediction with machine learning responsive to the communication request, consider the following discussion of FIG. 6.

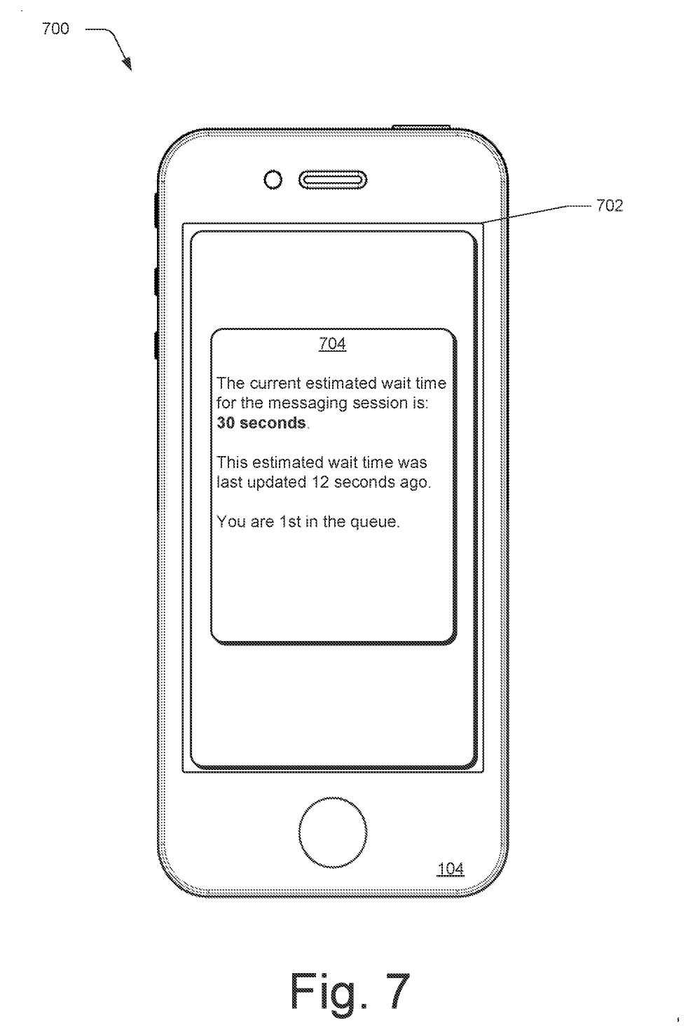

FIG. 6 depicts an example implementation 600 of a user interface 602 configured to broadcast a visual description of a wait time prediction generated with machine learning. The user interface 602, as illustrated for the client device 104, includes a description 604 including the wait time prediction 128 generated by a machine learning model, such as the updated machine learning model 308 of FIG. 3. As illustrated, the wait time prediction 128 is three minutes. The description 604 includes when the wait time prediction 128 was last updated (thirty-one seconds ago) and where the user’s communication request 132 from FIG. 5 is in the queue of other client devices. In the context of generating and broadcasting an updated wait time prediction, consider the following discussion of FIG. 7.

FIG. 7 depicts an example implementation 700 of a user interface 702 configured to broadcast a representation 704 of an updated wait time prediction generated with machine learning. The user interface 702, as illustrated for the client device 104, includes a representation 704 of the updated wait time prediction generated by an updated machine learning model based on updated recent communication data corresponding to updated recent communication requests. As illustrated, the representation 704 of the updated wait time prediction 410 is thirty seconds. In this example implementation 700, the representation 704 includes when the wait time prediction 410 was last updated (twelve seconds ago) and where the user’s communication request 132 from FIGS. 5 and 6 is in the queue of other client devices.

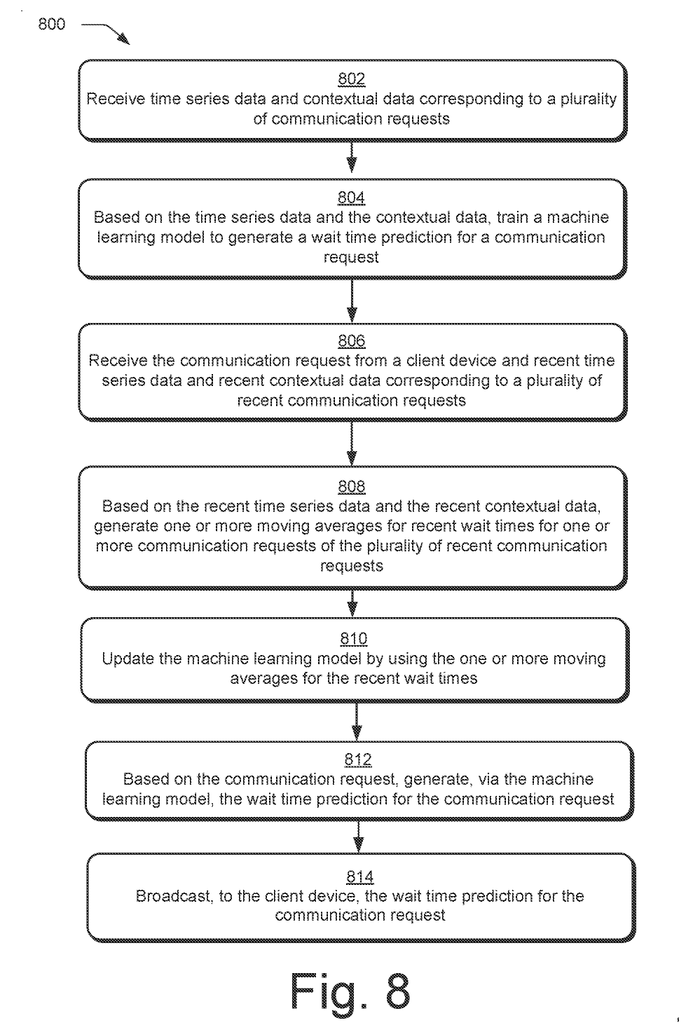

In the context of generating wait time predictions with machine learning, consider next the following discussion of FIG. 8.

### Example Procedures

The following discussion describes techniques which are implementable utilizing the previously described systems and devices. Aspects of each of the procedures are implementable in hardware, firmware, software, or a combination thereof. The procedures are shown as a set of blocks that specify operations performed by one or more devices and are not necessarily limited to the orders shown for performing the operations by the respective blocks. In portions of the following discussion, reference is made to FIGS. 1-8.

FIG. 8 depicts a procedure 800 in an example implementation of generating wait time predictions with machine learning. At block 802, time series data 208 and contextual data 210 corresponding to a plurality of communication requests is received. In some examples, the communication management system 118 receives the time series data 208 and the contextual data 210.

As discussed throughout, examples of the time series data 208 include datetimes (e.g., datetimes corresponding to communication requests, such as the plurality of communication requests), a day of a year, an hour of the day, a month of the year, a minute of the day, a day of a week, or a quarter of the year during which a communication request 132 was received, and so forth. Examples of the contextual data 210 include (e.g., for each communication request 132 received, at a time of receipt), a number of agent devices available, a priority type, a category type, a number of communication requests in a queue, and so forth.

At block 804, based on the time series data 208 and the contextual data 210, a machine learning model 126 is trained to generate a wait time prediction 128 for a communication request 132. In some embodiments, the model management module 204 is configured to train the machine learning model 126 based on the time series data 208 and the contextual data 210.

In some examples, the model management module 204 trains the machine learning model 126 by using a gradient boosting machine learning algorithm (e.g., XGBoost), however, any machine learning algorithm is usable by the model management module 204. Additionally, or alternatively, the model management module 204 uses time series analysis techniques for the training of the machine learning model 126. In some examples, the model management module 204 leverages auto regressive integrated moving averages. In some implementations, the model management module 204 uses a loss function (e.g., a pseudo-Huber loss function, a Huber loss function, etc.) as part of the training of the machine learning model 126.

At block 806, the communication request 132 from the client device 104 and recent time series data 304 and recent contextual data 306 corresponding to a plurality of recent communication requests is received. In some examples, the communication management system 118 receives the communication request 132 from the communication module 108 of the client device 104 and recent time series data 304 and recent contextual data 306 corresponding to the plurality of recent communication requests. By way of example, a selectable visual element 504 is selected via the user input 506 of the user interface 502 to communicate the communication request 132 to the communication management system 118.

At block 808, based on the recent time series data 304 and the recent contextual data 306, one or more moving averages for current wait times for one or more communication requests of the plurality of recent communication requests is generated. In some embodiments, the model management module 204 generates one or more moving averages for current wait times for one or more recent communication requests of the plurality of recent communication requests.

At block 810, by using the one or more moving averages for the current wait times, the machine learning model 126 is updated. In some examples, the model management module 204 generates the updated machine learning model 308 from the machine learning model 126 by using the one or more moving averages for the current wait times.

At block 812, based on the communication request 132, the wait time prediction 128 for the communication request 132 is generated via the machine learning model 308. In some examples, the prediction module 206 generates the wait time prediction 128 with the updated machine learning model 308 based on the communication request 132.

At block 814, the wait time prediction 128 for the communication request 132 is broadcasted to the client device 104. The prediction module 206 is configured to pass the prediction (e.g., the wait time prediction 128) to the communication module 108 of the client device 104. In some examples, the prediction module 206 is configured to render and/or generate one or more representations of the wait time prediction 128. Examples of the representations include audio representations, visual representations for display via the client device 104, and so forth. In the context of an example system and device for generating wait time predictions with machine learning, consider the following discussion of FIG. 9.

### Example System and Device

FIG. 9 illustrates an example system generally at 900 that includes an example computing device 902 that is representative of one or more computing systems and/or devices that implement the various techniques described herein. This is illustrated through inclusion of the communication management system 118 and the artificial intelligence service 114. The computing device 902 is configurable, for example, as a server of a service provider, a device associated with a client (e.g., a client device), an on-chip system, and/or any other suitable computing device or computing system.

The example computing device 902 as illustrated includes a processing system 904, one or more computer-readable media 906, and one or more I/O interface 908 that are communicatively coupled, one to another. Although not shown, the computing device 902 further includes a system bus or other data and command transfer system that couples the various components, one to another. A system bus includes any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 904 is representative of functionality to perform one or more operations using hardware. Accordingly, the processing system 904 is illustrated as including hardware element 910 that is configurable as processors, functional blocks, and so forth. This includes implementation in hardware as an application specific integrated circuit or other logic device formed using one or more semiconductors. The hardware elements 910 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 906 is illustrated as including memory/storage 912. The memory/storage 912 represents memory/storage capacity associated with one or more computer-readable media. The memory/storage 912 includes volatile media (such as random access memory (RAM)) and/or nonvolatile media (such as read only memory (ROM), Flash memory, optical disks, magnetic disks, and so forth). The memory/storage 912 includes fixed media (e.g., RAM, ROM, a fixed hard drive, and so on) as well as removable media (e.g., Flash memory, a removable hard drive, an optical disc, and so forth). The computer-readable media 906 is configurable in a variety of other ways as further described below.

Input/output interface(s) 908 are representative of functionality to allow a user to enter commands and information to computing device 902, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 902 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 902. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 902, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 910 and computer-readable media 906 are representative of modules, programmable device logic and/or fixed device logic implemented in a hardware form that are employed in some examples to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 910. The computing device 902 is configured to implement particular instructions and/or functions corresponding to the software and/or hardware modules. Accordingly, implementation of a module that is executable by the computing device 902 as software is achieved at least partially in hardware, e.g., through use of computer-readable storage media and/or hardware elements 910 of the processing system 904. The instructions and/or functions are executable/operable by one or more articles of manufacture (for example, one or more computing devices and/or processing systems 904) to implement techniques, modules, and examples described herein.

The techniques described herein are supported by various configurations of the computing device 902 and are not limited to the specific examples of the techniques described herein. This functionality is also implementable through use of a distributed system, such as over a “cloud” 914 via a platform 916 as described below.

The cloud 914 includes and/or is representative of a platform 916 for resources 918. The platform 916 abstracts underlying functionality of hardware (e.g., servers) and software resources of the cloud 914. The resources 918 include applications and/or data that can be utilized while computer processing is executed on servers that are remote from the computing device 902. Resources 918 can also include services provided over the Internet and/or through a subscriber network, such as a cellular or Wi-Fi network.

The platform 916 abstracts resources and functions to connect the computing device 902 with other computing devices. The platform 916 also serves to abstract scaling of resources to provide a corresponding level of scale to encountered demand for the resources 918 that are implemented via the platform 916. Accordingly, in an interconnected device example, implementation of functionality described herein is distributable throughout the system 900. For example, the functionality is implementable in part on the computing device 902 as well as via the platform 916 that abstracts the functionality of the cloud 914.

What is claimed is:

1. A computer-implemented method comprising:
receiving time series data and contextual data corresponding to a plurality of communication requests;
based on the time series data and the contextual data, training a machine learning model to generate a wait time prediction for a communication request;
receiving the communication request from a client device and recent time series data and recent contextual data corresponding to a plurality of recent communication requests;
based on the recent time series data and the recent contextual data, generating one or more moving averages for current wait times for one or more communication requests of the plurality of recent communication requests;
updating the machine learning model by using the one or more moving averages for the current wait times;
based on the communication request, generating, via the machine learning model, the wait time prediction for the communication request; and
broadcasting, to the client device, the wait time prediction for the communication request.

2. The computer-implemented method of claim 1, wherein the contextual data includes, for each communication request of the plurality of communication requests, at a time of receipt by a communication management system for the each communication request, one or more of a number of agent devices available, a priority type, or a number of communication requests in a queue.

3. The computer-implemented method of claim 1, wherein the time series data includes a plurality of datetimes, in which each datetime of the plurality of datetimes corresponds to a respective communication request of the plurality of communication requests at which the respective communication request was received by a communication management system.

4. The computer-implemented method of claim 1, wherein the time series data includes one or more of a day of a year, an hour of the day, a month of the year, a minute of the day, a day of a week, or a quarter of the year during which a respective communication request of the plurality of communication requests was received by a communication management system.

5. The computer-implemented method of claim 1, further comprising:
based on the recent time series data and the recent contextual data, generating one or more average wait times for one or more past time periods for one or more communication requests of the plurality of recent communication requests; and
updating the machine learning model by using the one or more average wait times from the one or more past time periods for the one or more communication requests.

6. The computer-implemented method of claim 5, wherein an average wait time of the one or more average wait times from the one or more past time periods is for a past minute.

7. The computer-implemented method of claim 1, further comprising:
based on the recent time series data and the recent contextual data, extracting one or more recent actual wait times; and
updating the machine learning model by using the one or more recent actual wait times.

8. The computer-implemented method of claim 1, wherein the training of the machine learning model is in part by using a gradient boosting algorithm.

9. The computer-implemented method of claim 1, further comprising:
receiving additional recent time series data and additional recent contextual data corresponding to a plurality of additional recent communication requests;
based on the additional recent time series data and the additional recent contextual data, generating one or more additional moving averages for current wait times;
updating the machine learning model by using the one or more additional moving averages for the current wait times;
based on the communication request, generating, via the machine learning model, an updated wait time prediction for the communication request; and
broadcasting, to the client device, the updated wait time prediction for the communication request.

10. The computer-implemented method of claim 1, further comprising:
detecting whether the communication request is fulfilled within the wait time prediction; and
updating the machine learning model based on the detecting.

11. The computer-implemented method of claim 1, further comprising:
adding the communication request to a queue of one or more communication requests responsive to receiving the communication request; and
removing the communication request from the queue of the one or more communication requests responsive to detecting fulfillment of the communication request.

12. A system comprising:
a memory component; and
a processing device coupled to the memory component, the processing device to perform operations comprising:
receiving time series data and contextual data corresponding to a plurality of communication requests;
based on the time series data and the contextual data, training a machine learning model to generate a wait time prediction for a communication request;
receiving the communication request from a client device and recent time series data and recent contextual data corresponding to a plurality of recent communication requests;
based at least in part on the recent time series data and the recent contextual data, extracting one or more recent actual wait times;
updating the machine learning model by using the one or more recent actual wait times for the one or more communication requests;
based on the communication request, generating, via the machine learning model, the wait time prediction for the communication request; and
broadcasting, to the client device, the wait time prediction for the communication request.

13. The system of claim 12, further comprising assigning a category type for the communication request based on one or more of the communication request, the recent time series data, or the recent contextual data, and wherein the generating of the wait time prediction for the communication request is based at least in part on the category type.

14. The system of claim 13, wherein the category type is a priority type.

15. The system of claim 13, further comprising:
receiving additional recent time series data and additional recent contextual data corresponding to a plurality of additional recent communication requests;
based on one or more of the communication request, the additional recent time series data, or the additional recent contextual data, updating the category type for the communication request;
based on the category type updated, generating an updated wait time prediction for the communication request by using the machine learning model; and
broadcasting, to the client device, the updated wait time prediction for the communication request.

16. The system of claim 12, wherein the training of the machine learning model further comprises applying a predefined rule-based filter to the time series data and the contextual data to extract filtered time series data and filtered contextual data, and wherein the training of the machine learning model comprises using the filtered time series data and the filtered contextual data.

17. The system of claim 12, further comprising:
receiving additional recent time series data and additional recent contextual data corresponding to a plurality of additional recent communication requests;
updating the machine learning model based on at least the additional recent time series data and additional recent contextual data;
generating an updated wait time prediction for the communication request by using the updated machine learning model; and
broadcasting, to the client device, the updated wait time prediction for the communication request.

18. The system of claim 12, further comprising generating a representation of the wait time prediction, and wherein the broadcasting of the wait time prediction is as the representation of the wait time prediction.

19. The system of claim 18, wherein the representation of the wait time prediction is a visual representation.

20. A non-transitory computer-readable storage medium storing executable instructions, which when executed by a processing device, cause the processing device to perform operations comprising:
receiving data corresponding to a plurality of communication requests, in which the data includes time series data and contextual data corresponding to the communication requests;
based on the time series data and the contextual data, training a machine learning model to generate a wait time prediction for a communication request;
receiving a communication request and recent time series data and recent contextual data corresponding to a plurality of recent communication requests;
based on the recent time series data and the recent contextual data, updating the machine learning model;
based on the communication request, generating, via the machine learning model, the wait time prediction for the communication request; and
broadcasting the wait time prediction for the communication request.
